(19) United States
(12) Patent Application Publication
(10) Pub. No.: US 2006/0109794 A1
(43) Pub. Date: May 25, 2006

(54) Communication system

(75) Inventors: Peter Muszynski, Espoo (FI); Jussi Jaatinen, Helsinki (FI); Jorma Kaikkonen, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/261,622

(22) Filed: Oct. 31, 2005

(30) Foreign Application Priority Data
Nov. 8, 2004 (GB) 0424628.6

(51) Int. Cl. H04J 3/14; H04B 7/00

(52) U.S. Cl. 370/251; 370/310

(57) ABSTRACT

There is disclosed a method of testing a network access element configured for demodulating an enhanced dedicated channel, E-DCH, with hybrid automatic repeat request, HARQ, functionality, the method comprising: transmitting E-DCH packets to the network access element; and selectively autonomously retransmitting E-DCH packets to the network access element.

### BACKGROUND TO THE INVENTION

1. Field of the Invention

The invention relates to the testing of transmissions in an uplink channel in a communication system, and particularly but not exclusively, to an enhanced dedicated channel in a UMTS system.

2. Description of the Related Art

A mobile communication system is an example of a system in which an access network is provided to allow access to the system functionality for user terminals.

In a universal mobile telecommunications system (UMTS), a radio access network typically provides access for user equipment to a mobile communications system core network. The user equipment typically communicates with the access network over a radio interface, the access network including a plurality of Node Bs or base stations, or more generally network access points, with which the user equipment establishes a connection. Each of the Node Bs is connected to one or more radio network controllers, or more generally network access controllers.

A dedicated channel (DCH) is provided in a UMTS system for uplink traffic from the user equipment to the radio network controller via the Node B. A frame transmission interval is defined for this channel. A typical and thus far the shortest frame transmission interval for dedicated channel is 10 ms.

In 3^{rd} Generation Partnership Project, Technical Specification Group Radio Access Network (3GPP TSG-RAN) there has been proposed high speed uplink packet access, also known in 3GPP as Frequency Division Duplex (FDD) Enhanced Uplink, including an enhanced DCH, E-DCH. This proposal is documented in 3GPP TR25.896.

A proposed characteristic of the E-DCH is to provide a shorter frame transmission interval of 2 ms. A further proposed functionality of the E-DCH is to support soft handover (SHO).

A still further proposed functionality of the E-DCH is a hybrid automatic repeat request (H-ARQ) error detection correction mechanism. This error control mechanism is proposed to be implemented in the Node B for uplink packets. In such an implementation, it is proposed to provide an E-DCH HARQ ACK indicator channel (E-HICH) for the network access point to transmit an indication of an error-free receipt of a data packet. The network access point transmits an acknowledgment ACK or none-acknowledgement NACK signal on the E-HICH in dependence on the outcome of the HARQ error-detection mechanism.

The testing of the functionality of network elements such as network access points is important, to ensure that elements deployed in a network operate correctly and reliably. For this reason, methods and apparatus for the testing network elements, such as network access points, are provided.

For the testing of the demodulation of the E-DCH channel, where HARQ is utilised, a feedback loop may be provided in order for the tester to receive and act on the signals in the E-HICH channel. However this increases the complexity of the tester, requiring the tester to process the E-HICH channel.

### SUMMARY OF THE INVENTION

It is an aim of the invention to provide an efficient mechanism for testing a network access point, and particularly for testing the demodulation of an E-DCH channel in a network access point.

There is provided a method of testing a network access element configured for demodulating an enhanced dedicated channel, E-DCH, with hybrid automatic repeat request, HARQ, functionality, the method comprising: transmitting E-DCH packets to the network access element; and autonomously retransmitting E-DCH packets to the network access element. The autonomous retransmission may be selective.

The steps of transmitting and retransmitting E-DCH packets may comprise transmitting packets via a channel simulator.

The method may further comprise adding noise to the transmitted packets.

The steps of transmitting and retransmitting E-DCH packets may comprise transmitting E-DCH packets on multiple paths. Each path may be associated with a channel simulator. Noise may be applied to the packets on each path.

The step of autonomously retransmitting E-DCH packets may comprise retransmitting E-DCH packets according to a deterministic pattern.

The step of autonomously retransmitting E-DCH packets may comprise retransmitting E-DCH packets according to a pseudo-random pattern.

The method may include establishing a DPCCH, E-DPDCH and an E-DPCCH channel.

The invention may further provide a tester for testing a network access element having functionality for demodulating an enhanced dedicated channel, E-DCH, with hybrid automatic repeat request, HARQ, functionality, the tester comprising: means for transmitting E-DCH packets to the network access element; and means for autonomously retransmitting E-DCH packets to the network access element. The means for autonomously retransmitting may be controlled to selectively retransmit.

The means for transmitting and retransmitting E-DCH packets may include a channel simulator.

The means for transmitting and retransmitting E-DCH packets may include noise means for applying noise to the transmitted packets.

The means for transmitting and retransmitting E-DCH packets may include multiple outputs for transmitting packets on multiple paths.

Each output may be connected to a channel simulator.

There may be provided a plurality of noise means for adding noise to each path.

The means for autonomously retransmitting E-DCH packets may comprise a deterministic pattern transmission means.

The means for autonomously retransmitting E-DCH packets may comprise a pseudo-random pattern transmission means.

The tester may include means for establishing a DPCCH, E-DPDCH and an E-DPCCH channel.

There may be provided a network access element having functionality for demodulating an enhanced dedicated channel, E-DCH, with hybrid automatic repeat request, HARQ, functionality, the network access point being provided with a means, enabled in a test mode of operation for disabling an acknowledgement transmission responsive to receipt of an E-DCH packet.

There may be provided a method of testing a network access element configured for demodulating an enhanced dedicated channel, E-DCH, with hybrid automatic repeat request, HARQ, functionality, the method comprising: transmitting E-DCH packets to the network access element; and autonomously retransmitting E-DCH packets to the network access element, wherein the method further includes disabling an acknowledgement transmission at the network access point.

### BRIEF DESCRIPTION OF THE FIGURES

The invention will now be described by way of example with reference to the accompanying figures, in which:

FIG. 1 illustrates a closed-loop test architecture suitable for testing the demodulation of the E-DCH channel in multipath fading conditions for a network access point with receiver diversity;

FIG. 2 illustrates a closed-loop test architecture suitable for testing the demodulation of the E-DCH channel in multipath fading conditions for a network access point with receiver diversity; and

FIG. 3 illustrates an exemplary radio access network in which a radio access network element under test may be deployed.

### DESCRIPTION OF THE PREFERRED EMBODIMENTS

The invention is described herein by way of reference to particular example scenarios. In particular the invention is described in relation to elements of a universal mobile communication telecommunications system (UMTS).

Referring to FIG. 1, there is illustrated a general closed-loop testing architecture for the demodulation performance of E-DCH with hybrid ARQ. A base station under test is denoted by reference numeral 114. In this example, the test is performed in multipath fading conditions for a base station with receiver diversity. In a specific example of FIG. 1, the test is carried out for two multipaths, the base station thus having a first input denoted 116a for receiving a first multipath and a second input 116b for receiving a second multipath. It should be noted, however, that in the following description embodiments of the invention are described in the context of two multipaths for illustrative purposes only. The invention may be applied in an arrangement with one path, or two or more multipaths. In this example, the first input 116a also acts as an output for the base station under test to transmit control signals, as discussed further hereinbelow.

Within the test architecture, a transmit output 120 of the base station tester 102 is connected to a channel generator 104. The channel generator generates the DPCCH, E-DPDCH, and E-DPCCH channels. These channels must be generated in order to support the transmission of E-DCH data packets from the base station tester 102 to the base station under test 114. In the test architecture, the channel generator 104 then has multiple outputs corresponding with the number of multipaths in the test architecture, in this case being two. A first output of the channel generator 104 forms an input to a first channel simulator 106a, and a second output of the channel generator 104 forms an input to a second channel simulator 106b. Each of the channel simulators simulates real-life channel conditions, and acts on data packets transmitted from the base station tester 102 to the base station under test 114 in accordance with the appropriate simulator channel conditions. Each of the channel simulators 106a and 106b has a respective output which forms a first input to a respective combiner 110a and 110b. Each of the combiners 110a and 110b has a respective second input, which is received from the output of an additive white Gaussian noise (AWGN) generator 108a and 108b. The AWGN generators 108a and 108b apply noise to the data packets at the output of the channel simulators in order to make the baseband test independent from the base station radio frequency noise figure. The combined outputs of the respective combiners 110a and 110b are provided to the two input ports 116a and 116b of the base station under test 114. The output of the combiner 110a is provided to the input port 116a via a device 112 which also enables signals to be transmitted from the port 116a towards the base station tester, as discussed further hereinbelow.

In operation, once the channel generator 104 has set-up the necessary channels to establish a communication link between the base station tester 102 and the base station under test 114, E-DCH packets are transmitted from the base station tester to the base station under test.

In the closed-loop test architecture arrangement of FIG. 1, responsive to the receipt of E-DCH packets the base station under test transmits control signals on an E-HICH channel to the base station tester 102. The reply packets transmitted by the base station under test are output at the port 116a, via the device 112, to a link 118 which is received at a received input 122 of the base station tester 102. The control signals on the E-HICH channel are signals which indicate whether the received data packets on the E-DCH channel are successfully processed by the HARQ functionality in the base station under test 114. The control signal is either an acknowledgement signal ACK or a non-acknowledgement signal NACK, indicating successful or unsuccessful HARQ processing of the received packets respectively. A P-CPICH channel is also established with a return path between the base station and the test 114 and the base station tester 102. By receiving the control signals on the E-HICH channel, the base station tester 102 may operate appropriately in accordance with the received control signal to transmit new E-DCH packets toward the base station under test or re-transmit E-DCH packets which have been indicated to a failed HARQ processing at the base station under test. In this way, real-life processing is simulated, with the base station test 102 effectively acting as a user equipment (UE) emulator. From the above, it can be appreciated that as a minimum the base station tester 102 is required to contain the functionality for the following:
1. generating the DPCCH, E-DBDCH, and E-DPCCH channels;
2. generating packets for E-DCH reference measurement channels (assuming “buffer full” conditions);
3. demodulating the E-HICH channel, including the ACK and NACK control information. Sufficient power may be allocated to the E-HICH by the base station under test such that reception is essentially error-free; and
4. responding to the ACK and NACK control signals by appropriate packet re-transmission and RSN signalling on the E-DPCCH.

It will be apparent to one skilled in the art that the test architecture arrangement of FIG. 1 is well-matched to the testing of HARQ functionality due to the nature of the HARQ re-transmissions depending on the feedback of the ACK and NACK control signals from the base station under test. However the impact of implementing the feedback functionality required to receive and process the ACK and NACK control signals in the base station tester, and then re-transmit packets where necessary in the base station tester, increases the required complexity of implementation of the base station tester 102.

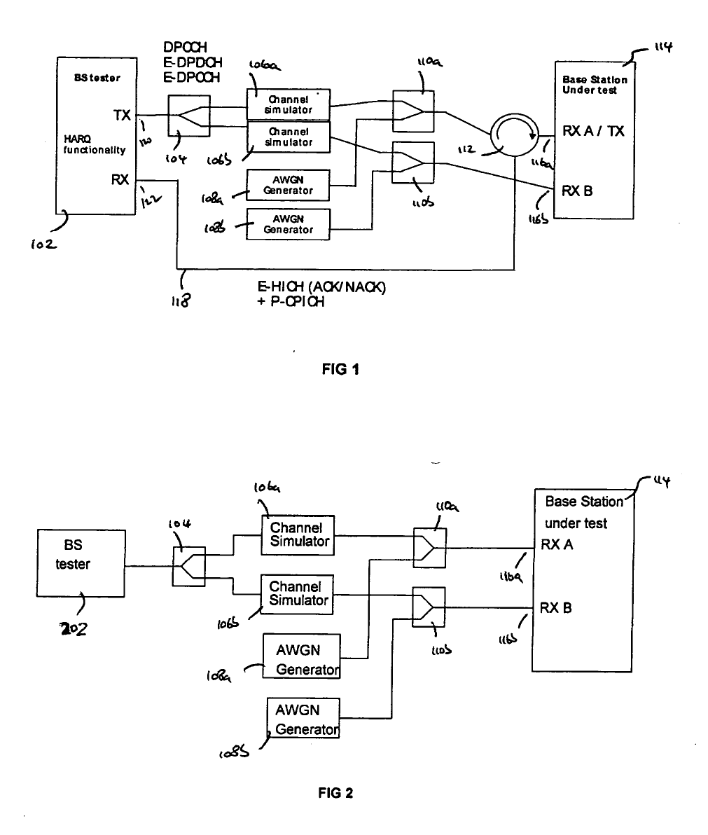

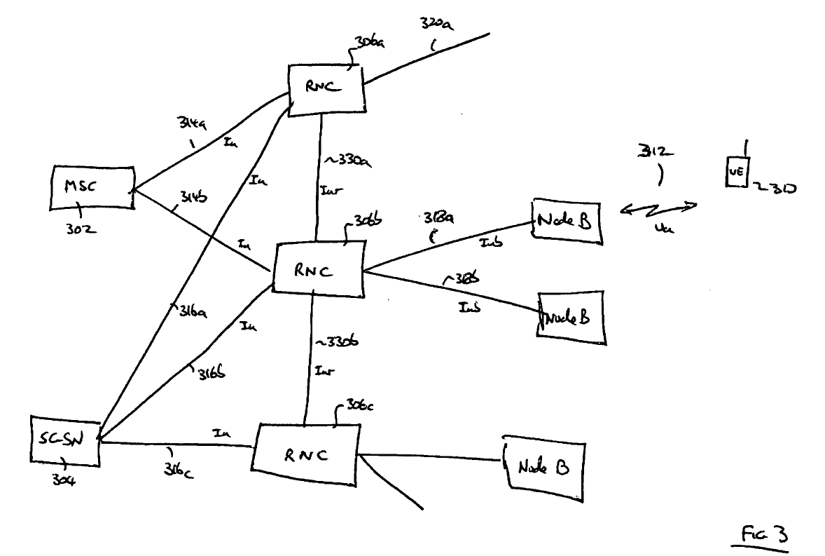

Referring to FIG. 2, there is now described an improved test architecture for demodulation of E-DCH in multipath fading conditions for a base station with receiver diversity. Where appropriate, elements of FIG. 2 which correspond to elements of FIG. 1 are denoted by the same reference numerals. The test architecture shown in FIG. 2 is an open-loop architecture. The base station tester 202 is different from the base station tester 102, as functionality to support feedback loop is not required. The test architecture is similar to that of FIG. 1, but the device 112 is not needed since for test purposes the base station under test 114 is not required to transmit signals back to the base station tester 202. Thus the output of the combiner 110a is directly connected to the input port 116a of the base station under test.

In operation, the base station tester generates and transmits E-DCH packets once the appropriate channels have been established by the channel generator 104. As discussed with relation to FIG. 1, the channel generator 104 generates the channels DPCCH, E-DPDCH, and E-DPCCH. The base station tester 202 is further adapted to autonomously generate packet re-transmissions. The base station under test 114 receives the E-DCH packets transmitted by the base station tester 202, and any packet re-transmissions, and demodulates and processes said packets and packet re-transmissions according to the rules of the E-DCH HARQ protocol.

In autonomously generating packet re-transmissions, the base station tester 202 may follow a deterministic pattern. Alternatively, for example, the base station tester 202 may follow a pseudo-random pattern. The autonomous packet re-transmissions from the base station tester 202, whether according to a deterministic pattern, a pseudo-random pattern, or otherwise, may be generated according to a probabilistic model.

The base station under test 114 responds to the autonomous packet re-transmissions according to the E-DCH HARQ protocol. By choosing an appropriate, i.e. low, Eb/No operating point, it can be ensured that only base stations having a correct and well-performing E-DCH HARQ functionality can pass the test. Thus, by providing a low signal-to-noise ratio on the E-DCH packets transmitted, it can be ensured that high performing base stations pass the test. Typically receivers using HARQ can provide significant throughput even when the Eb/No operating point is so low that conventional (i.e. non-HARQ) receivers will only experience a block error rate (BLER) of over 90%. Test cases can be designed in a way that the HARQ gain is several decibels, so that receivers without E-DCH HARQ are easily discriminated.

The preferable output of this test is the amount of correctly delivered packets (i.e. throughput) at a given Eb/No operating point.

An advantageous feature of the open loop test architecture of FIG. 2 is that the test coverage also includes the impact of ACK and NACK misdetection, and soft handover (SHO), on HARQ operation.

Even when packets are received by a base station in error, and an NACK signal is transmitted by the base station, packets may still often not be re-transmitted by user equipment. This is equivalent to the misdetection of an NACK signal as an ACK signal and the user equipment. Alternatively, such an error may occur in a soft handover operation where another base station sends an ACK signal to the user equipment. In such a case the base station is expected to reset the HARQ buffer.

In another error situation, packets may be re-transmitted even though they have already been received correctly, and an ACK signal has been sent by the base station. This is equivalent to an ACK signal being misdetected by a user equipment as an NACK signal. In such case the base station under test is expected to discard the packet.

Both of the cases described above are HARQ recovery actions for common error modes of the HARQ protocol, and would not typically be tested in a closed loop scheme with reliable demodulation of the E-HICH channel.

The base station under test can determine from the channel coding cyclic redundancy code check (CRC) whether the test driven by the base station tester is passed, i.e. if the received packets are demodulated correctly. From the total number of packet sent, and those passed, the throughput can be determined. The throughput must exceed a threshold for the base station to pass the test.

For completeness, referring to FIG. 3, there is illustrated a typical UMTS system within which a network access point configured to demodulate an E-DCH channel may be deployed. The implementation of a UMTS system will be well-known to one skilled in the art.

Referring to FIG. 3, an example UMTS system may typically include a mobile switching centre (MSC) 302, a serving GPRS support node (SGSN) 304, a plurality of radio network controllers (RNCs) 306a, 306b, 306c, a plurality of Node Bs 308a, 308b, 308c, and at least one user equipment (UE) 310.

In practice, the MSC functionality may be provided by an MSC Server (MSS) and a Media Gateway (MGW).

As is known in the art, the at least one user equipment 310 connects with one of the Node Bs, for example Node B 308a, over a radio interface 312, known in the 3GPP UMTS system as a Uᵤ interface.

Each Node B is connected to at least one RNC via an I_{ub} interface. The RNC 306b connects to the Node Bs 308a and 308b via I_{ub} interfaces 318a and 318b respectively, and possibly to one or more other Node Bs. The RNC 306c connects to the Node B 308c via I_{ub} interface 322a, and to one or more other Node Bs via one or more other I_{ub} interfaces, such as interface 322b. The RNC 306a connects to one or more Node Bs via one or more I_{ub} interfaces, such as interface 320a. Various RNCs may connect to various Node Bs, as known in the art.

The RNCs themselves are interconnected via Iᵤᵣ interfaces. In FIG. 3, it is shown that the RNC 106a is connected to the RNC 306b via an Iᵤᵣ interface 330a, and the RNC 306b is connected to the RNC 306c via an Iᵤᵣ interface 330b. The RNCs 306a and 306c may similarly be interconnected via an Iᵤᵣ interface. The various RNCs may be interconnected via Iᵤᵣ interface.

Each of the RNCs in the UMTS system is connected to one or more MSCs or SGSNs via an Iᵤ interface. In the example of FIG. 3, the MSC 302 is connected to the RNCs 306a and 306b via respective Iᵤ interfaces 314a and 314b, and the SGSN 304 is connected to the RNCs 306a, 306b and 306c via respective Iᵤ interfaces 314a, 314b and 314c.

The enhanced DCH uplink transport channel is a channel for transporting traffic from a user equipment to a Node B in the radio interface Uᵤ, and for transporting traffic from a Node B to an RNC, and between RNCS, on the I_{ub} interface or the Iᵤᵣ interface.

It is proposed to utilise the hybrid automatic repeat request (H-ARQ) error control mechanism in the various Node Bs to configure the frame protocol packet data units (PDUs) on the I_{ub} interface to convey only those transport blocks (TBs) that are determined to be useful. Thus, it is proposed that those transport blocks that the H-ARQ error control is not able to correct are not sent over the I_{ub}. Thus the HARQ is preferably used to adapt the transmission in the uplink channel between a Node B and a radio network controller to transfer only those transport blocks which pass the error control applied.

By excluding transport blocks which fail error control on the I_{ub} interface, the transmission bandwidth on this interface can be significantly saved. The frame protocol frame may have a variable length, depending upon the transport blocks included therein, which provides a variability in the offered load of the I_{ub} interface. The statistical multiplexing gain in the I_{ub} transport interface is thus increased. The invention, and embodiments thereof, provides an efficient mechanism for testing this functionality.

In general, the Node B may be considered to be a network access point, being a point at which a user terminal, such as a user equipment or mobile terminal, accesses a network. In general, the radio network controller may be considered to be a network access controller, being an element which controls network access.

The invention has been described herein by way of reference to particular non-limiting examples. One skilled in the art will understand the general applicability of the invention. The scope of protection afforded by the invention is defined in the appended claims.

1. A method of testing a network access element configured for demodulating an enhanced dedicated channel, E-DCH, with hybrid automatic repeat request, HARQ, functionality, the method comprising: transmitting E-DCH packets to the network access element; and autonomously retransmitting E-DCH packets to the network access element.

2. A method according to claim 1 wherein the steps of transmitting and retransmitting E-DCH packets comprise transmitting packets via a channel simulator.

3. A method according to claim 1 the method further comprising adding noise to the transmitted packets.

4. A method according to claim 1 wherein the steps of transmitting and retransmitting E-DCH packets comprise transmitting E-DCH packets on multiple paths.

5. A method according to claim 4, wherein a channel simulator is associated with each path.

6. A method according to claim 4, wherein noise is applied to the packets on each path.

7. A method according to claim 1 wherein the step of autonomously retransmitting E-DCH packets comprises retransmitting E-DCH packets according to a deterministic pattern.

8. A method according to claim 1 wherein the step of autonomously retransmitting E-DCH packets comprises retransmitting E-DCH packets according to a pseudo-random pattern.

9. A method according to claim 1 including establishing a DPCCH, E-DPDCH and an E-DPCCH channel.

10. A tester for testing a network access element having functionality for demodulating an enhanced dedicated channel, E-DCH, with hybrid automatic repeat request, HARQ, functionality, the tester comprising: means for transmitting E-DCH packets to the network access element; and means for autonomously retransmitting E-DCH packets to the network access element.

11. A tester according to claim 10 wherein the means for transmitting and retransmitting E-DCH packets include a channel simulator.

12. A tester according to claim 10 wherein the means for transmitting and retransmitting E-DCH packets includes noise means for adding noise to the transmitted packets.

13. A tester according to claim 10 wherein the means for transmitting and retransmitting E-DCH packets includes multiple outputs for transmitting packets on multiple paths.

14. A tester according to claim 13, wherein a channel simulator is connected to each output.

15. A tester according to claim 13, wherein there is provided a plurality of noise means for adding noise to each path.

16. A tester according to claim 10 wherein the means for autonomously retransmitting E-DCH packets comprises a deterministic pattern transmission means.

17. A tester according to claim 10 wherein the means for autonomously retransmitting E-DCH packets comprises packets comprises a pseudo-random pattern transmission means.

18. A tester according to claim 10 including means for establishing a DPCCH, E-DPDCH and an E-DPCCH channel.

19. A network access element having functionality for demodulating an enhanced dedicated channel, E-DCH, with hybrid automatic repeat request, HARQ, functionality, the network access point being provided with a means, enabled in a test mode of operation for disabling an acknowledgement transmission responsive to receipt of an E-DCH packet.

20. A method of testing a network access element configured for demodulating an enhanced dedicated channel, E-DCH, with hybrid automatic repeat request, HARQ, functionality, the method comprising: transmitting E-DCH packets to the network access element; and selectively autonomously retransmitting E-DCH packets to the network access element, wherein the method further includes disabling an acknowledgement transmission at the network access point.
